(19) United States
(12) Patent Application Publication
(10) Pub. No.: US 2009/0214282 A1
(43) Pub. Date: Aug. 27, 2009

(54) HOUSING AND RECORDING APPARATUS

(75) Inventors: Kaoru KOIKE, Matsumoto-shi (JP); Toshio KUMAGAI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/391,930

(22) Filed: Feb. 24, 2009

(30) Foreign Application Priority Data
Feb. 25, 2008 (JP) 2008-042680
Oct. 8, 2008 (JP) 2008-261721

(51) Int. Cl. B41J 11/00

(52) U.S. Cl. 400/613

(57) ABSTRACT

A housing includes a hollow body case having a communicating portion that communicates the interior and the exterior with each other; a first shaft accommodated in the body case and supporting a recording medium wound into roll form; and a second shaft accommodated in the body case and taking up the recording medium that is let out from the interior of the body case to the exterior from the first shaft via the communicating portion and again introduced from the exterior of the body case into the interior via the communicating portion. The second shaft is movable relative to the body case so that the shortest distance to the inner circumferential surface of the body case increases as the second shaft takes up the recording medium.

### BACKGROUND

1. Technical Field

The present invention relates to a housing for accommodating, for example, a roll recording medium and to a recording apparatus that records on a recording medium let out from the housing and wound around the outer circumferential surface of the housing.

2. Related Art

A known recording apparatus in the related art for recoding on a recording medium that is wound around the outer circumferential surface of a housing is an ink jet printer (hereinafter simply referred to as a printer) disclosed in JP-A-2003-94615 (FIG. 7). This printer is configured such that a feed roller (a first shaft) on which a roll medium (a recording medium) is wound and a take-up roller (a second shaft) are accommodated in a drum (a body case). The roll medium let out from the feed roller runs around the outer circumferential surface of the drum and is then sequentially taken up by the take-up roller. A line-head unit (a recording unit) ejects ink onto the roll medium located on the outer circumferential surface of the drum while the drum is rotating to thereby print (record) on the roll medium.

Since the printer disclosed in JP-A-2003-94615 is configured such that the feed roller and the take-up roller are rotatably supported in the drum so as to be parallel to the axis of the drum at a predetermined interval, the maximum outside diameter of a roll medium that can be set around the feed roller can be increased only to half of the inside diameter of the drum. Therefore, to further increase the amount of a roll medium that can be set around the feed roller, the drum must be increased in accordance with the increased outside diameter of the roll medium, thus posing the problem of increasing the size of the drum.

### SUMMARY

An advantage of some aspects of the invention is that a housing and a recording apparatus are provided in which the amount of a roll recording medium that can be accommodated in a body case can be increased without increasing the body case.

A housing according to a first aspect of the invention includes a hollow body case having a communicating portion that communicates the interior and the exterior with each other; a first shaft accommodated in the body case and supporting a recording medium wound into roll form; and a second shaft accommodated in the body case and taking up the recording medium that is let out from the interior of the body case to the exterior from the first shaft via the communicating portion and again introduced from the exterior of the body case into the interior via the communicating portion. The second shaft is movable relative to the body case so that the shortest distance to the inner circumferential surface of the body case increases as the second shaft takes up the recording medium.

This configuration can increase the outside diameter of the recording medium that can be taken up by the second shaft in the body case by moving the second shaft relative to the body case so that the shortest distance to the inner circumferential surface of the body case increases as the second shaft takes up the recording medium. This can increase the amount of the recording medium that can be accommodated in the body case without increasing the size of the body case.

In this case, it is preferable that the first shaft be movable relative to the body case so that the shortest distance to the inner circumferential surface of the body case decreases as the second shaft takes up the recording medium.

This configuration can further increase the outside diameter of the recording medium that can be taken up by the second shaft in the body case by moving the first shaft relative to the body case so that the shortest distance to the inner circumferential surface of the body case decreases as the second shaft takes up the recording medium.

In this case, it is preferable that the recording medium that is let from the interior of the body case to the exterior from the first shaft via the communicating portion be wound around the outer circumferential surface of the body case.

This configuration allows the outer circumferential surface of the body case to be used as a support for supporting the recording medium during printing on the print medium.

In this case, it is preferable that the housing further include guide members that guide the first shaft and the second shaft when at least the second shaft of the first and second shafts moves relative to the body case.

This configuration allows the first shaft and the second shaft to be guided when at least the second shaft of the first and second shafts moves relative to the body case.

In this case, it is preferable that the housing further include a moving mechanism, wherein the body case be rotatable about the main shaft; the first shaft and the second shaft extend along the main shaft and can be moved by the moving mechanism in the direction perpendicular to the main shaft; and the moving mechanism include a joint member that rotatably joins the first shaft and the second shaft together, the joint member being slidable together with the first shaft and the second shaft.

This configuration allows the accommodation space in the body case o be used effectively, thus increasing the outside diameter of the recording medium that can be accommodated in the body case. Furthermore, the first shaft and the second shaft can be slid by the joint member while keeping a fixed distance therebetween. This can prevent interference between the recording medium wound around the first shaft and the recording medium wound around the second shaft when the recording medium let out from the first shaft is taken up by the second shaft.

A recording apparatus according to a second aspect of the invention includes the housing with the above configuration and a recording unit that records on the recording medium at the outside of the body case.

This configuration can increase the amount of a recording medium that can be accommodated in the body case without increasing the size of the body case.

### BRIEF DESCRIPTION OF THE DRAWINGS

The invention will be described with reference to the accompanying drawings, wherein like numbers reference like elements.

FIG. 1 is a front perspective view of an ink jet printer according to an embodiment of the invention.

FIG. 2 is a front view of the printer in which a paper roll is set on a first shaft.

FIG. 3 is a back perspective view of the printer.

FIG. 4 is a plan view of the printer.

FIG. 5 is a back view of the printer.

FIG. 6 is a front view of the printer in which the paper roll is taken up by a second shaft.

### DESCRIPTION OF EXEMPLARY EMBODIMENTS

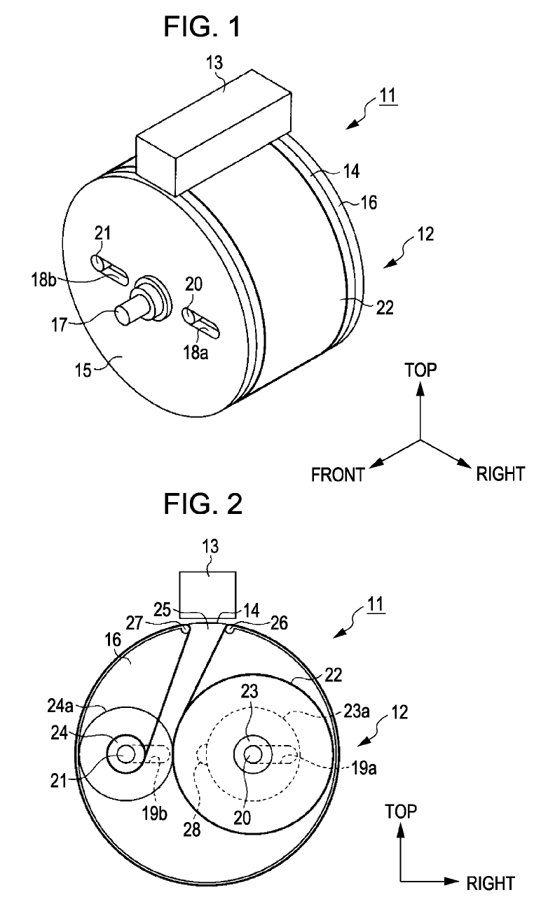

An embodiment that embodies a recording apparatus of the present invention in an ink jet printer will be described below with reference to the drawings. In the following description, “a front-to-back direction”, “a lateral direction”, “the top and bottom” are indicated by the arrows in FIG. 1.

As shown in FIG. 1, an ink jet printer 11 corresponding to a recording apparatus includes a hollow columnar body case 12 and a rectangular record head 13 serving as a recording unit disposed on the top of the body case 12. The body case 12 includes a cylindrical case 14 having an opening at the front and rear ends, a disc-shaped front lid 15 attached to the opening at the front end of the case 14 so as to close it, and a disc-shaped rear lid 16 attached to the opening at the rear end of the case 14 so as to close it. A support shaft 17 rotatably projects toward the front from the center of the front lid 15. The front end of the support shaft 17 is supported by a support member (not shown).

As shown in FIGS. 1 and 2, the front lid 15 is provided with a pair of long through holes 18a and 18b that are long in the lateral direction, which serve as guide members, on either side of the support shaft 17. On the other hand, the rear lid 16 is provided with a pair of long through holes 19a and 19b, which serve as guide members like the long holes 18a and 18b, at the positions corresponding to the long holes 18a and 18b. The long holes 18a and 19a are located on the right of the support shaft 17.

As shown in FIGS. 1 to 4, a first shaft 20 extending in the front-to-back direction passes through the left ends of the long holes 18a and 19a. The first shaft 20 is slidable in the lateral direction along the long holes 18a and 19a. The front end face of the first shaft 20 is flush with the outer surface of the front lid 15, and the rear end of the first shaft 20 projects rearward from the rear lid 16. On the other hand, a second shaft 21 extending in the front-to-back direction passes through the left ends of the long holes 18b and 19b. The second shaft 21 is slidable in the lateral direction along the long holes 18b and 19b. The front end face of the second shaft 21 is flush with the outer surface of the front lid 15, and the rear end of the second shaft 21 projects rearward from the rear lid 16. In this embodiment, the body case 12, the first shaft 20, and the second shaft 21 constitute a housing (a recording-medium housing) for accommodating a recording medium.

As shown in FIG. 2, in the case 14, a cylindrical first core member 23 around which a paper roll 22, which is a recording medium, is wound is detachably fitted on the first shaft 20. In this case, the length of the paper roll 22 is set so that the outside diameter of the paper roll 22 is slightly larger than half of the inside diameter of the case 14. A disc flange 23a for restricting the front-to-back movement of the paper roll 22 is provided at the front and rear ends of the first core member 23. When the first shaft 20 is rotated, with the first core member 23 fitted on the first shaft 20, the first core member 23 is rotated together with the first shaft 20.

On the other hand, in the case 14, a cylindrical second core member 24 is detachably fitted on the second shaft 21. A disc flange 24a that restricts the front-to-back movement of the paper roll 22 in the case where the paper roll 22 is wound around the second core member 24 is provided at the front and rear ends of the second core member 24. When the second shaft 21 is rotated, with the second core member 24 fitted on the second shaft 21, the second core member 24 is rotated together with the second shaft 21.

A communicating portion 25 that communicates the interior and the exterior of the case 14 with each other is formed at the upper end of the case 14. The end of the communicating portion 25 at the right of the case 14 is a right edge 26, and the end of the communicating portion 25 at the left the case 14 of is a left edge 27. The paper roll 22 let out from the first core member 23 is threaded through the right edge 26, is then wound around the outer circumferential surface of the case 14, is threaded through the left edge 27, and is then wound around the second core member 24. Accordingly, when the second shaft 21 is rotated in the direction in which the second core member 24 takes up the paper roll 22 (in FIG. 2, clockwise), the paper roll 22 let out from the first core member 23 is transported around the outer circumferential surface of the case 14 and is sequentially wound around the second core member 24.

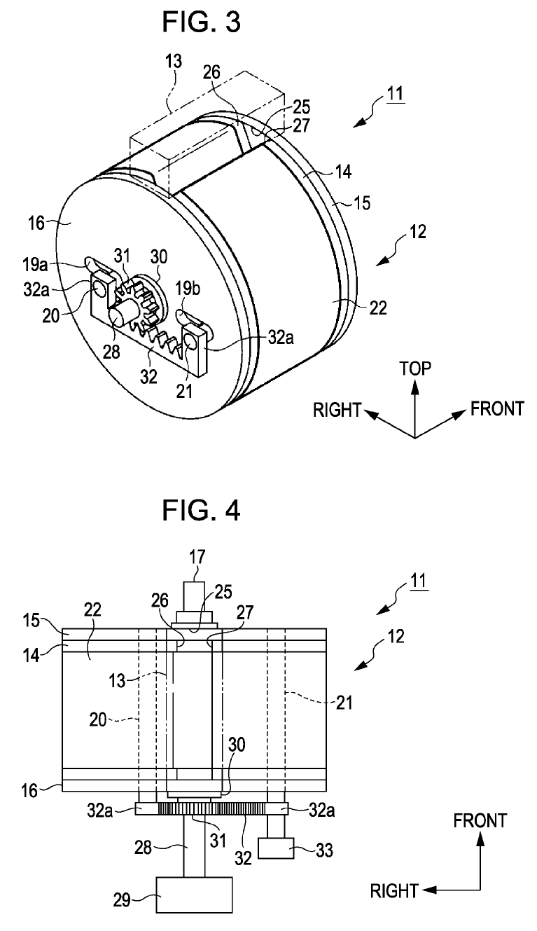

As shown in FIGS. 3 to 5, the rear lid 16 is made of a material attracted by a magnetic force. A main shaft 28 rotatably projects rearward from the center of the rear lid 16. Accordingly, the main shaft 28 and the support shaft 17 are located on the same axis extending in the front-to-back direction. The main shaft 28 is rotatably supported by a support member (not shown). The rear end of the main shaft 28 is connected to a main-shaft motor 29 that is a driving source for rotationally driving the main shaft 28. The front end of the main shaft 28 is firmly fixed to a ring-shaped plate electromagnet 30. The front surface of the electromagnet 30 is in slidable contact with the outer surface of the rear lid 16. The electromagnet 30 can be supplied with power by a power source (not shown). A pinion 31 is firmly fixed at the back of the electromagnet 30 on the main shaft 28.

A rack 32 serving as a joint member extending in the lateral direction is disposed at the bottom of the pinion 31 in such a manner that it engages with the pinion 31. The rack 32 rotatably connects the first shaft 20 and the second shaft 21. That is, the rack 32 is provided with upwardly projecting connecting pieces 32a at the right and left ends thereof. The connecting pieces 32a are connected to the first shaft 20 and the second shaft 21 so as to allow the rotation of the first shaft 20 and the second shaft 21, respectively. As the pinion 31 rotates, the first shaft 20 and the second shaft 21 can slide in the lateral direction together with the rack 32. The rear end of the second shaft 21 is connected to a take-up motor 33 for rotationally driving the second shaft 21.

In this embodiment, the main-shaft motor 29, the main shaft 28, the pinion 31, and the rack 32 constitute a moving mechanism.

The lower surface, facing the outer circumferential surface of the case 14, of the record head 13 has a plurality of nozzles for ejecting ink, which is liquid, supplied from an ink cartridge (not shown). By ejecting ink from the nozzles (not shown) of the record head 13 while rotating the body case 12 (housing) about the main shaft 28, the part of paper roll 22 wound around the outer circumferential surface of the body case 12 is subjected to printing, which is recording.

Next, the operation of the ink jet printer 11 will be described.

To print on the paper roll 22 by the ink jet printer 11, first, the electromagnet 30 is fed with electricity. Then, the rear lid 16 is attracted to the electromagnet 30 and thus the body case 12 rotates together with the rotation of the main shaft 28. In this state, when the main-shaft motor 29 is driven to rotate the main shaft 28, the rotating force of the main shaft 28 is transferred to the body case 12 via the electromagnet 30 to rotate the body case 12. At that time, by ejecting ink from the nozzles (not shown) of the record head 13, the part of the paper roll 22 wound around the outer circumferential surface of the case 14 is printed. In this case, the outer circumferential surface of the case 14 functions as a platen for supporting the paper roll 22.

When the body case 12 makes one rotation, the second shaft 21 is rotated by the take-up motor 33, so that the paper roll 22 is taken up by the second core member 24 by the length of the paper roll 22 wound around the outer circumferential surface of the case 14. The taking-up of the paper roll 22 causes the first shaft 20 to rotate, so that the paper roll 22 is let out from the first core member 23 by the length of the paper roll 22 taken up by the second core member 24 due to the rotation of the first core member 23.

When printing is repeated in the unit of the length of the paper roll 22 wound around the outer circumferential surface of the body case 12 in this way, the outside diameter of the paper roll 22 wound around the second core member 24 increases as the outside diameter of the paper roll 22 wound around the first core member 23 decreases. When the outside diameter of the paper roll 22 wound around the second core member 24 increases, the shorted distance between the paper roll 22 wound around the second core member 24 and the inner circumferential surface of the case 14 decreases, and the paper roll 22 wound around the second core member 24 and the inner circumferential surface of the case 14 come into contact at some point in time. Therefore, by stopping the power supply to the electromagnet 30 to cancel the state in which the rear lid 16 is attracted to the electromagnet 30 immediately before the paper roll 22 wound around the second core member 24 comes into contact with the inner circumferential surface of the case 14, the rotating force of the main shaft 28 becomes unable to be transferred to the body case 12.

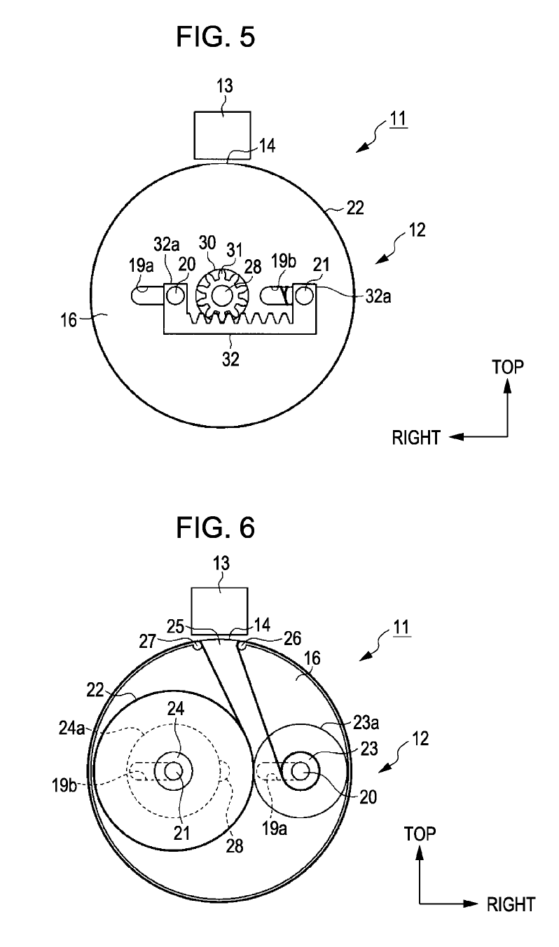

In this state, when the main-shaft motor 29 is driven to rotate the main shaft 28 clockwise in FIG. 5, the rotating force is transferred to the rack 32 through the pinion 31, so that the rack 32 slides to the right together with the first shaft 20 and the second shaft 21. At that time, the rack 32 is slid immediately before the paper roll 22 wound around the first core member 23 comes into contact with the inner circumferential surface of the case 14. Furthermore, at that time, the first shaft 20 and the second shaft 21 are guided to the right by the long holes 18a and 19a and the long holes 18b and 19b, respectively.

This increases the shortest distance between the paper roll 22 wound around the second core member 24 and the inner circumferential surface of the case 14 and decreases the shortest distance between the paper roll 22 wound around the first core member 23 and the inner circumferential surface of the case 14. By repeating printing, in a state in which almost all of the paper roll 22 wound around the first core member 23 is taken up by the second core member 24, the first shaft 20 and the second shaft 21 move to the right ends of the long holes 18a and 19a and the right ends of the long holes 18b and 19b, as shown in FIG. 6. At that time, the paper roll 22 taken up by the second core member 24 and the inner circumferential surface of the case 14 are not in contact with each other.

Thus, this embodiment is configured such that the first shaft 20 and the second shaft 21 slide to the right at the same time while keeping a fixed distance therebetween as the paper roll 22 is taken up by the second core member 24. Therefore, even if the outside diameter of the paper roll 22 wound around the first core member 23 is larger than half of the inside diameter of the case 14, the paper roll 22 taken up by the second core member 24 does not come into contact with the paper roll 22 remaining around the first core member 23 or with the inner circumferential surface of the case 14.

The embodiment described in detail offers the following advantages:

1. Since the first shaft 20 and the second shaft 21 slide to the right at the same time while keeping a fixed distance therebetween as the paper roll 22 is taken up by the second core member 24, the outside diameter of the paper roll 22 that can be taken up by the second core member 24 (the second shaft 21) in the body case 12 can be larger than the related art. That is, the amount of the paper roll 22 that can be accommodated in the body case 12 can be increased without increasing the size of the body case 12.

2. The paper roll 22 let out from the interior of the body case 12 to the exterior from the first core member 23 (the first shaft 20) through the communicating portion 25 is wound around the outer circumferential surface of the body case 12. Therefore, the outer circumferential surface of the case 14 can be used as a support (platen) for supporting the paper roll 22 during printing on the paper roll 22.

3. Since the first shaft 20 and the second shaft 21 slidably pass through the long holes 18a and 19a and the long holes 18b and 19b, respectively, the first shaft 20 and the second shaft 21 can be surely guided to the right using the long holes 18a and 19a and the long holes 18b and 19b.

4. The body case 12 is rotatable about the main shaft 28 extending in the front-to-back direction, and the first shaft 20 and the second shaft 21 extend along the main shaft 28 and can move in the lateral direction perpendicular to the main shaft 28. This allows the accommodation space in the body case 12 to be used effectively, thus increasing the outside diameter of the paper roll 22 that can be accommodated in the body case 12.

5. Since the housing has a moving mechanism for moving the first shaft 20 and the second shaft 21, the first shaft 20 and the second shaft 21 can be surely moved in the lateral direction by the moving mechanism.

6. The first shaft 20 and the second shaft 21 are rotatably joined together with the rack 32, and the rack 32 is slidable in the lateral direction together with the first shaft 20 and the second shaft 21. Therefore, the first shaft 20 and the second shaft 21 can be slid in the lateral direction at the same time while keeping a fixed distance therebetween. This can prevent interference between the paper roll 22 wound around the first core member 23 and the paper roll 22 wound around the second core member 24 when the paper roll 22 let out from the first core member 23 (the first shaft 20) is taken up by the second core member 24 (the second shaft 21).

7. Since the main-shaft motor 29 for rotationally driving the main shaft 28 serves also as a driving source for slidably driving the rack 32 in the lateral direction, there is no need to provide another driving source for slidably driving the rack 32 in the lateral direction. This can decrease the components of the ink jet printer 11, thus contributing to the size reduction of the ink jet printer 11.

8. Since the pinion 31 and the rack 32 are in engagement, the rotating force of the main shaft 28 can be surely transferred to the rack 32 via the pinion 31 as a sliding moving force for slidably moving the rack 32 in the lateral direction. That is, the engagement of the pinion 31 and the rack 32 ensures that the rack 32 is slidably moved in the lateral direction together with the rotation of the main shaft 28.

### Modifications

The above embodiment may be modified as follows:

The driving source for slidably moving the rack 32 in the lateral direction may be another driving source different from the main-shaft motor 29.

The long holes 18a and 18b may be changed to grooves that do not pass through the front lid 15.

The paper roll 22 let out from the interior of the body case 12 to the exterior from the first core member 23 (the first shaft 20) through the communicating portion 25 may be introduced from the exterior of the body case 12 to the interior via a separate platen and again through the communicating portion 25 and then may be taken up by the second core member 24 (the second shaft 21). In this case, the record head 13 is disposed so as to face the paper roll 22 on the platen. This eliminates the need to rotate the body case 12 during printing on the paper roll 22.

In this case, the first shaft 20 and the second shaft 21 may not be moved but the body case 12 may be moved in the lateral direction. Alternatively, both the first shaft 20 and the second shaft 21 and the body case 12 may be moved.

The first shaft 20 may not be supported by the long holes 18a and 19a. That is, the long holes 18a and 19a may be omitted.

The rack 32 may be omitted. In this case, a separate moving means for moving the second shaft 21 in the lateral direction is needed.

The first shaft 20 may not necessarily be movable.

The first shaft 20 may be moved in any direction perpendicular to the first shaft 20 provided that it is a direction in which the shortest distance from the inner circumferential surface of the case 14 decreases.

The second shaft 21 may be moved in any direction perpendicular to the second shaft 21 provided that it is a direction in which the shortest distance from the inner circumferential surface of the case 14 increases.

Although in the above embodiment a recording apparatus is embodied in the ink jet printer 11, it may be embodied in a plate printer.

Although in the above embodiment a recording apparatus is embodied in the ink jet printer 11, it may be embodied in a liquid ejection apparatus that ejects another liquid other than ink (including liquid-form matter in which particles of a functional material is dispersed or mixed and fluid-form matter such as gel). “Liquid” in this specification includes, for example, inorganic solvents, organic solvents, solutions, liquid resin, and liquid metal (metal melt) and also liquid-form matter and fluid-form matter.

What is claimed is:

1. A housing comprising:
a hollow body case having a communicating portion that communicates the interior and the exterior with each other;
a first shaft accommodated in the body case and supporting a recording medium wound into roll form; and
a second shaft accommodated in the body case and taking up the recording medium that is let out from the interior of the body case to the exterior from the first shaft via the communicating portion and again introduced from the exterior of the body case into the interior via the communicating portion, wherein
the second shaft is movable relative to the body case so that the shortest distance to the inner circumferential surface of the body case increases as the second shaft takes up the recording medium.

2. The housing according to claim 1, wherein the first shaft is movable relative to the body case so that the shortest distance to the inner circumferential surface of the body case decreases as the second shaft takes up the recording medium.

3. The housing according to claim 1, wherein the recording medium that is let from the interior of the body case to the exterior from the first shaft via the communicating portion is wound around the outer circumferential surface of the body case.

4. The housing according to claim 2, further comprising guide members that guide the first shaft and the second shaft when at least the second shaft of the first and second shafts moves relative to the body case.

5. The housing according to claim 1, further comprising a moving mechanism, wherein
the body case is rotatable about the main shaft;
the first shaft and the second shaft extend along the main shaft and can be moved by the moving mechanism in the direction perpendicular to the main shaft; and
the moving mechanism includes a joint member that rotatably joins the first shaft and the second shaft together, the joint member being slidable together with the first shaft and the second shaft.

6. A recording apparatus comprising the housing according to claim 1 and a recording unit that records on the recording medium at the outside of the body case.
